(19) United States
(12) Patent Application Publication
(10) Pub. No.: US 2025/0189459 A1
(43) Pub. Date: Jun. 12, 2025

(54) IMAGING AND ANALYZING CRACK PROPAGATION IN GLASS

(71) Applicant: CORNING INCORPORATED, CORNING, NY (US)

(72) Inventor: Davide Giassi, Big Flats, NY (US)

(21) Appl. No.: 18/967,909

(22) Filed: Dec. 4, 2024

Related U.S. Application Data
(60) Provisional application No. 63/606,649, filed on Dec. 6, 2023.

(51) Int. Cl. G01N 21/88; G01N 21/958

(52) U.S. Cl. CPC G01N 21/8851; G01N 21/958; G01N 2021/8829; G01N 2021/8874; G01N 2021/889; G01N 2201/062; G01N 2201/0633; G01N 2201/102

(57) ABSTRACT

An imaging system for acquiring time-resolved images of crack propagation in glass samples includes a light source and data camera in a shadowgraph detector configuration, and a trigger camera to acquire images over an appropriate time window to capture crack propagation. Suitable software-based processing and analysis methods facilitate identifying individual cracks, branchpoints, and fragments in the images, as well as measuring their individual and statistical properties.

### CROSS-REFERENCE TO RELATED APPLICATIONS

This application claims the benefit of priority to U.S. Provisional Patent Application No. 63/606,649 filed on Dec. 6, 2023, the content of which is incorporated herein by reference in its entirety for all purposes.

### BACKGROUND

A fundamental understanding of the performance of glass compositions for display cover materials and similar applications entails a grasp of the behavior of glass samples under static and dynamic stresses, which is generally evaluated with “frangibility tests.” These tests are experiments designed to understand how glass responds to fracture driven only by stored internal energy from a residual stress profile. In a standard frangibility test, the minimum force to initiate fracture by indentation is first measured to minimize energy contributions. After fracture, the fragments are counted. Currently, there is no measurement data regarding how and in what order the cracks propagate and branch, and how quickly they travel and accelerate. Due to this absence of crack propagation data, many hypotheses regarding energy transfer and fragmentation as they relate to glass composition and stress profile are without direct empirical support and rely on only partially validated simulations.

### BRIEF DESCRIPTION OF THE DRAWINGS

Described herein, with reference to the accompanying drawings, are systems and methods for acquiring, processing, and analyzing time-resolved images of crack propagation in glass samples.

FIG. 1A-1D shows a selected sequence of raw images depicting an example crack propagation and branching event.

FIG. 2A is a raw image of an example final crack structure, and FIGS. 2B-2D show corresponding processed images that have been color-coded to denote the identified fragments, branchpoints and their classifications, and identified cracks, respectively.

FIGS. 3A-3D are bar diagrams illustrating example statistical distributions of measured fragment area, fragment eccentricity, crack length, and crack average velocity obtained for an example glass sample by processing and analyzing time-resolve images of crack propagation in accordance with an embodiment.

FIG. 4A is a schematic perspective view of an example imaging system that facilitates time-resolved imaging of crack propagation in a glass sample, in accordance with an embodiment.

FIG. 4B is a flowchart illustrating a method of time-resolved imaging of crack propagation in a glass sample with the imaging system 400 of FIG. 4A, in accordance with an embodiment.

FIG. 5 is a flowchart providing an overview of methods of processing and analyzing time-resolved images of crack propagation in a glass sample, in accordance with various embodiments.

FIGS. 6A-6D are example processed images of a glass sample prior to crack formation, illustrating masking and dust correction steps in accordance with an embodiment.

FIGS. 7A and 7B are zoomed-in views of the images of FIGS. 6A and 6D, showing dust present in the uncorrected image and isolated dust after identification, respectively.

FIGS. 8A-8F are example processed images of a glass sample following completion of crack propagation, illustrating the individual image normalization and extraction of the final crack structure in accordance with an embodiment.

FIGS. 9A-9B and 9C-9D are example processed images of a crack structure and image kernels, respectively, illustrating crack interpolation in accordance with an embodiment.

FIG. 10 is a zoomed-in portion of an example crack structure image, illustrating interpolation of a gap in a crack.

FIGS. 11A and 11B are zoomed-in portions of an example crack structure image, illustrating extrapolation of a crack in accordance with an embodiment.

FIGS. 12A-12F are example processed images of a glass sample, showing the temporal evolution of a crack during crack propagation.

FIGS. 13A-13C are example crack structure images illustrating crack extremities conditioning in accordance with one embodiment.

FIG. 14A is an example instantaneous crack structure image with a red dot identifying the location of a generic branchpoint just reached by a propagating crack.

FIG. 14B is an example difference image between the crack structure image of FIG. 14A and an earlier image, computed as part of determining the time of first branchpoint occurrence, in accordance with one embodiment.

FIGS. 15A-15D are zoomed-in views, surrounding a branchpoint of interest, of example difference images computed for a sequence of time steps as part of determining the time of first branchpoint occurrence.

FIGS. 16A and 16B are example square kernels surrounding a branchpoint in two successive images, illustrating classification of the branchpoint as an endpoint.

FIG. 17 is a processed image of an example crack structure with branchpoints color-coded to indicate the classification, determined in accordance with one embodiment, into instantaneous split points (green), delayed split points (orange), and endpoints (red).

FIGS. 18A and 18B are portions of an example skeleton structure and corresponding crack structure, respectively, color-coded to visually indicated individual cracks identified in accordance with an embodiment.

FIG. 19A is an example processed image of a crack structure, showing the coordinates of a specific crack, as determined accordance with one embodiment, superimposed in cyan.

FIG. 19B is a zoomed-in view of FIG. 19A, in which the individual crack extremity coordinates along the specific crack can be discerned.

FIG. 20 shows the crack structure of FIG. 19A with all the various crack extremities superimposed, separated and labeled by different colors based on the crack they belong to.

FIG. 21 is an example processed image of a highly fragmented sample at some time during crack propagation, illustrating an extremities wavefront.

FIGS. 22A-22D are plots illustrating wavefront displacement measurements in accordance with an embodiment.

FIGS. 23A-23C illustrate an example iterative process for quantifying the branching angles, in accordance with an embodiment.

FIG. 24 is a block diagram of an example machine for implementing the image-processing and analysis methods described herein.

### DESCRIPTION

The present disclosure provides an optical imaging system capable of acquiring high-quality, time-resolved images of cracks propagating through glass samples prior to disintegration, as well as computer-implemented (e.g., software-implemented) image-processing and analysis methods for identifying and tracking cracks in the images as a function of time to extract quantitative information. While conventional frangibility tests have been limited to counting the glass fragments generated after impact, the disclosed approach allows identifying and analyzing the final crack structure to also quantify geometric properties of the fragments and their statistical distributions. In addition, since the disclosed systems and methods are able to detect and track the extremities of cracks propagating through the glass sample as a function of time, they allow identifying individual cracks and the locations of crack branching (herein “branchpoints”), classifying the branchpoints into split points, delayed split points, and endpoints (as defined and explained below), determining statistical branching metrics, and calculating instantaneous and average velocity and accelerations of the extremities, whose results can be conditioned base on the branching analysis.

Measurements of crack velocity and acceleration, and how they change as the crack propagates and branches, can lead to an improved understanding of the relationship between internal energy and crack behavior. Additionally, the measurements and improved understanding contribute to the advancement of simulative tools for glass composition design and crack behavior prediction by providing unprecedented validation data. The ability to evaluate and quantify behavior of glass as it cracks is important to understand, for example, how automotive glass or cover glass for displays break after impact and which type of fragments are generated, or how glass derived from different batch composition reacts to impact.

Example embodiments of a time-resolved imaging system and image-processing and analysis methods have been applied to frangibility tests of 50 mm by 50 mm glass coupons, as illustrated with raw and processed images of the coupons included in the accompanying drawings. As will be appreciated by those of the ordinary skill in the art, application of the disclosed system and methods can, of course, be extended to other glass substrates with varying sizes.

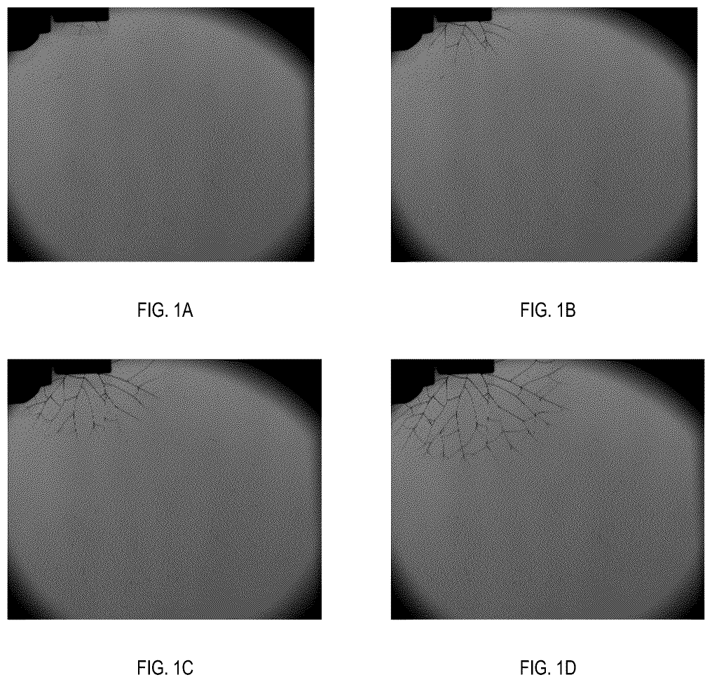

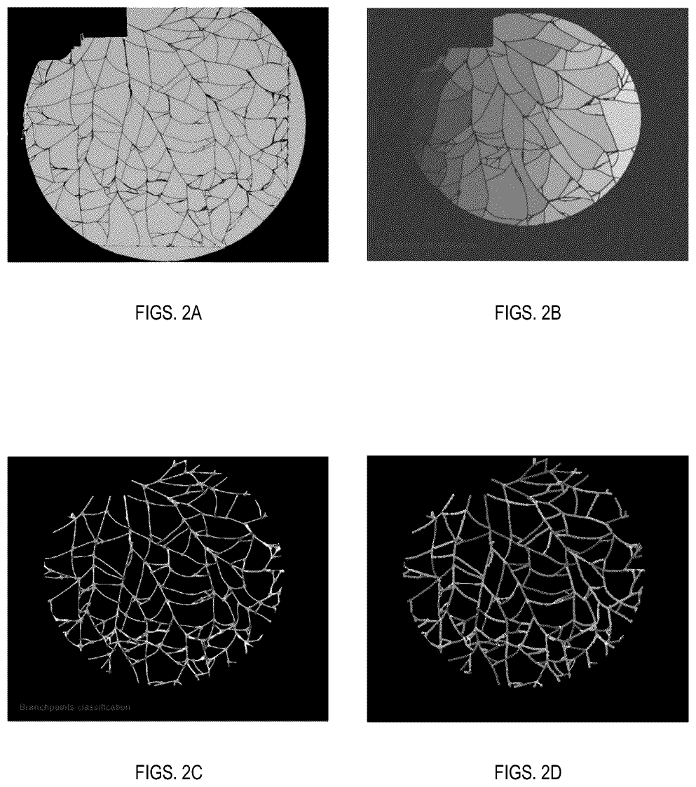

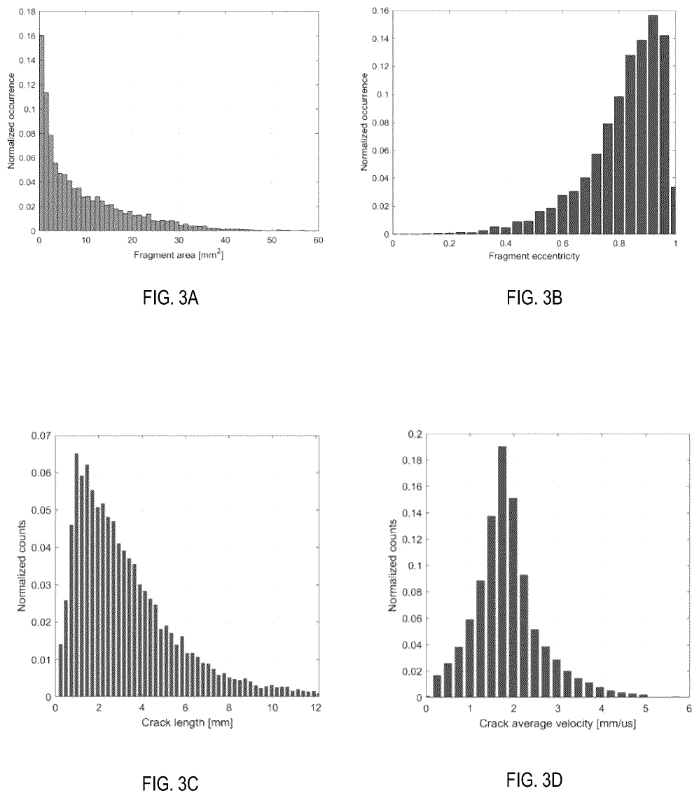

FIGS. 1A-3D illustrate some of the capabilities of the disclosed system and methods. FIGS. 1A-1D show a selected sequence of raw images depicting an example crack propagation and branching event in a 50 mm by 50 mm glass coupon. FIG. 2A shows a raw image of an example final crack structure, and FIGS. 2B-2C show corresponding processed images. More specifically, in FIG. 2B, the final crack structure has been colored to visualize the identified fragments. In FIG. 2C, the branchpoints have been color-coded to distinguish between split points (green), where a crack branches into two or more cracks, and endpoints (red), where a propagating crack meets an existing crack. In FIG. 2D, the final crack structure has been colored to visualize the identified cracks. FIGS. 3A-3D are bar diagrams illustrating example statistical distributions of measured fragment area, fragment eccentricity, crack length, and crack average velocity obtained for an example glass sample by processing and analyzing time-resolved images of crack propagation in accordance with an embodiment.

### Optical Imaging System

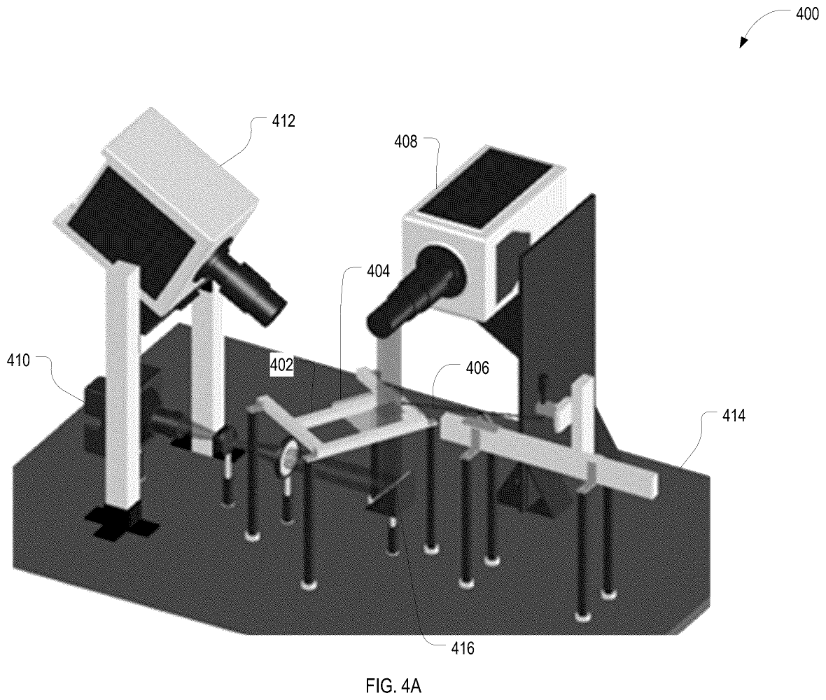

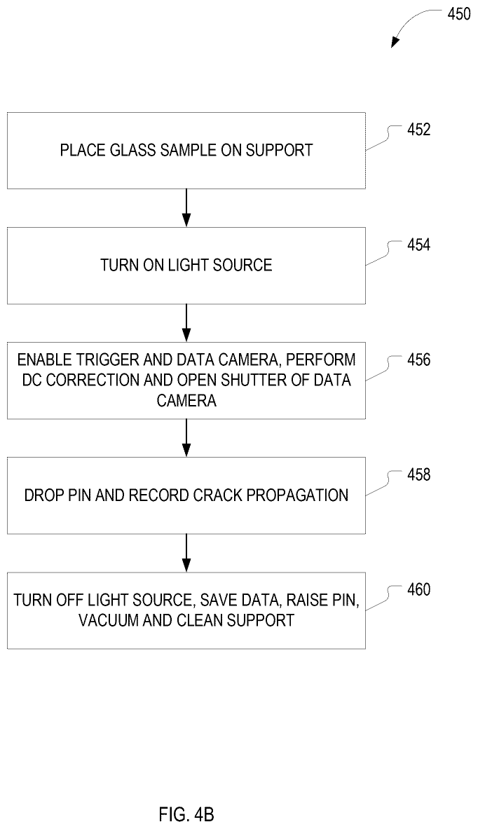

FIG. 4A is a schematic perspective view of an example imaging system 400 that facilitates time-resolved imaging of crack propagation in a glass sample, in accordance with an embodiment. The system 400 includes a support 402 for holding the glass sample 404, and placed around the sample 404, a crack initiator mechanism 406, a light source 408 and data camera 410 in shadowgraph detector configuration, and a trigger camera 412.

The support 402 may be a transparent substrate, e.g., made of borosilicate glass, onto which the glass sample 404 is placed, as shown. Alternatively, the support may be a frame that holds the glass sample 404 only around the edges, leaving a central opening that defines the area of the sample 404 that is being imaged. The support 402 may be mounted above an optics breadboard 414, e.g., at a height on the order of centimeters or decimeters (e.g., 30 cm). The crack initiator mechanism 406 is located adjacent to the support 402, and may include a movable pin, e.g., made of hardened steel or another metal, to be dropped onto the glass sample 404. The pin may be mounted in a manner to be perpendicular to the glass sample upon impact, and may be adjustable in height to enable initiating a crack in the glass sample 404 with minimum energy. For example, the pin may be mounted on the end of a steel rod, and the height of the opposing end of the rod may be controlled with a linear micrometer, which allows setting the height of the steel pin above the glass sample 404 accurately and reproducibly. The proper height of the pin above the glass sample 404 may be specifically determined for each glass composition and sample thickness to initiate the crack with minimal kinetic energy. The glass sample may be positioned relative to the pin so that the pin hits a region close to one of corners of the sample, e.g., at a distance of about 5 mm from the edges, to avoid occluding the sample with the pin-supporting structure and/or metal, thus maximizing the useful imaged area.

During frangibility tests, the glass sample 404 is imaged in a shadowgraph configuration. That is, the glass sample 404 is placed, generally perpendicularly, between the light source 408 and the data camera 410 serving as detector. At discontinuities—such as cracks—in the sample, light is scattered away from its path and therefore not collected by the imaging detector; as a result, the background of the image will be bright, while the cracks will appear darker. To reduce the effects of irradiance lost over distance and diffraction blurring of small cracks, the light output by the light source may be collimated. Further, the light may be monochromatic or narrowband (e.g., spanning less than 50 nm) to limit diffraction and provide better image contrast and less blurring. In some embodiments, the light source 408 includes a scientific light emitting diode (LED) and, at its output an iris (e.g., having an opening of less than a millimeter in diameter) to increase the coherence of the light and collimate the light into a parallel beam. The LED may emit in the blue region, e.g., at 450 nm; illuminating the sample at such short wavelengths serves to minimize the ratio of wavelength to crack thickness, making thin cracks easier to visualize. In the depicted implementation, the collimated beam is reflected at a mirror by 90° and sent perpendicularly through the glass sample 404. After passing through the sample 404, the light is reflected by a second mirror 416 and collected by the data camera 410. Of course, other geometric configurations are also conceivable.

The data camera 410 is a high-speed camera (or a “hyper-speed” camera, to distinguish it from the slower, yet also high-speed trigger camera 412) that captures images at a rate sufficient to temporally resolve the propagation of a crack in the sample 404. In various embodiments, the data camera 410 captures images at a frame rate of at least 5 MHz (i.e., five million frames per second, that is, every 200 ns). The data camera 410 includes a circular buffer of a size sufficient to store images over a time period covering the expected duration of crack propagation in the sample 404, such as, in some embodiments, a time period of at least 25 μs. For example, the data camera 410 may collect 180 time-resolved images at 5 MHZ, corresponding to 36 μs; such a camera is commercially available. As will be appreciated by those of ordinary skill in the art, limitations on the available buffer size generally present a trade-off between the frame rate and the covered time period of the camera, which requires careful selection of the camera based on the type and size of glass sample and the anticipated time scales of crack propagation.

When the metal pin impacts the glass sample 404, a short amount of time passes before a crack starts forming. This small delay between the impact and the initiation of a crack is on the order of tens of microseconds, and is highly variable, due to a variable amount of energy stored in each glass sample 404 that is based on the composition of the glass and the duration of ion exchange and purity of the bath during glass manufacture. Since the hyper-speed data camera 410 can record data only over a short time period dependent on the frame rate and maximum memory size (e.g., 36 us in the above example), the variable crack initiation delays would in many instances cause crack propagation to be missed within the image data if image acquisition were synchronized with the pin drop onto the sample. In accordance with this disclosure, therefore, the timing of image acquisition is tied to the onset of crack formation rather than the impact of the pin. More specifically, the data camera 410 acquires images continuously (from the time of or prior to the pin drop), continuously overwriting the buffer, but ceases image acquisition and overwriting responsive to a trigger signal generated upon detection of a crack.

For purposes of generating that trigger signal, a second, normal high-speed camera (e.g., having a frame rate of less than 1 MHz), equipped with an onboard image-based auto trigger (IBAT) capability that is able to detect changes in the image signal in real time, is used as trigger camera 412. The trigger camera 412 may, for instance, acquire images at a rate of 380 kHz. Using appropriate user set thresholds, when the trigger camera 412 detects the crack, it generates an electrical transistor-transistor logic (TTL) pulse, which is fed to the hyper-speed data camera 410, causing the data camera 410 to cease overwriting recorded image frames. Signal delays can be calibrated to configure the trigger camera 412 and data camera 410 such that the data camera 410 captures the full crack propagation, that is, continues acquiring images long enough to capture the end of crack propagation, but not so long as to overwrite the portion of the circular buffer that stores the beginning of crack propagation. For example, the read-out and processing circuitry that implements the IBAT capability of the trigger camera 412 may generate the trigger signal within 12 us of the onset of crack formation in the glass sample, and upon arrival of the pulse at the data camera 410 a few microseconds later, the data camera may continue image acquisition for a specified time (e.g., another 5 μs) to ensure capturing the full crack propagation. This optical triggering strategy has proven fast, accurate, and reliable, and facilitates a near 100% successful data collection capturing the entirety of the crack propagation event.

FIG. 4B is a flowchart illustrating a method 450 of time-resolved imaging of crack propagation in a glass sample with the imaging system 400 of FIG. 4A. Operating the system 400 involves, first, placing a glass sample 404 on the substrate or other support 402 (step 452). To avoid touching and influencing the sample edges, the repeatability of sample placement may be ensured using the edges of a tape, glued to the substrate, as a reference. In conventional frangibility tests, the glass sample 404 had to be taped down on the substrate to avoid shattering and enable imaging the crack structure after completion of crack propagation, which changed the boundary conditions of the experiments and likely skewed the results. Beneficially, using real-time imaging of crack propagation in accordance herewith obviates the need for taping down the sample, providing higher fidelity of the results to real-world scenarios of glass cracking.

Once the glass sample 404 is in place, the light source 408 is turned on to illuminate the sample 404 (step 454). Then, the trigger and data cameras 412, 410 are enabled, and the data camera performs a DC correction and opens its mechanical shutter (step 456). With the trigger and data cameras running and the data camera 410 capturing shadowgraph images of the sample 404 and cyclically storing the images in a circular buffer, the pin of the crack initiator mechanism is then dropped from the minimum crack initiation height (step 458), causing a crack to form. The data camera 410 records propagation of the crack, and stops overwriting frames in the circular buffer responsive to successful triggering by the trigger camera 412. In one example, the data camera records 180 frames at 5 MHz, for a total acquisition time of 36 μs. Finally, the light source is turned off to avoid overloading the chip, the recorded data is saved (for instance, by reading out the circular buffer and storing the image frames, e.g., in TIFF format, to data storage of a computer), the metal pin is raised, the glass fragments are vacuumed from the substrate, and the substrate is wiped with a cloth or otherwise cleaned to remove debris (step 460). These steps are generally repeated for each glass sample.

### Image Processing and Analysis Software

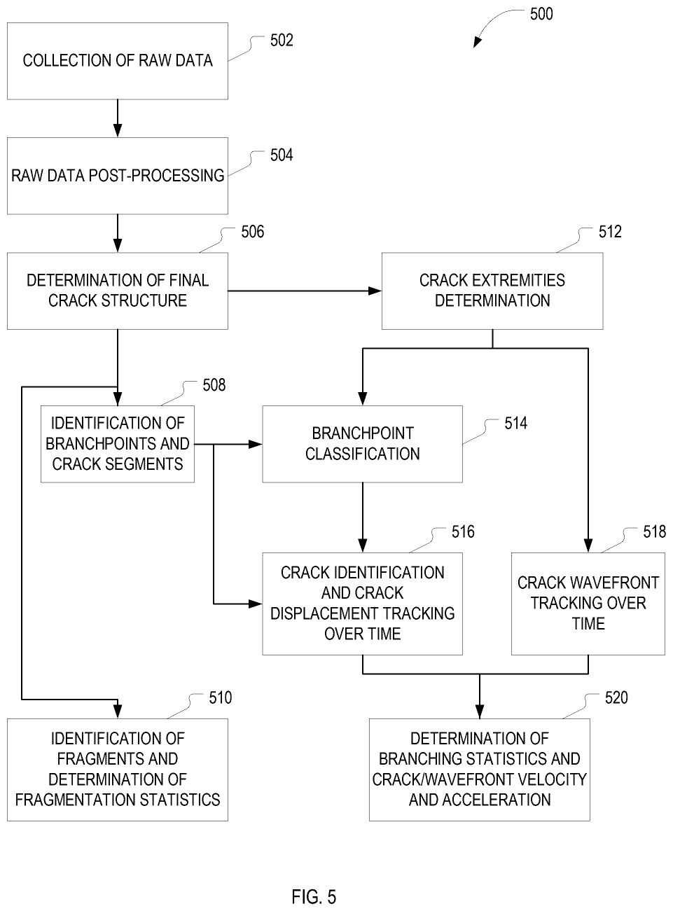

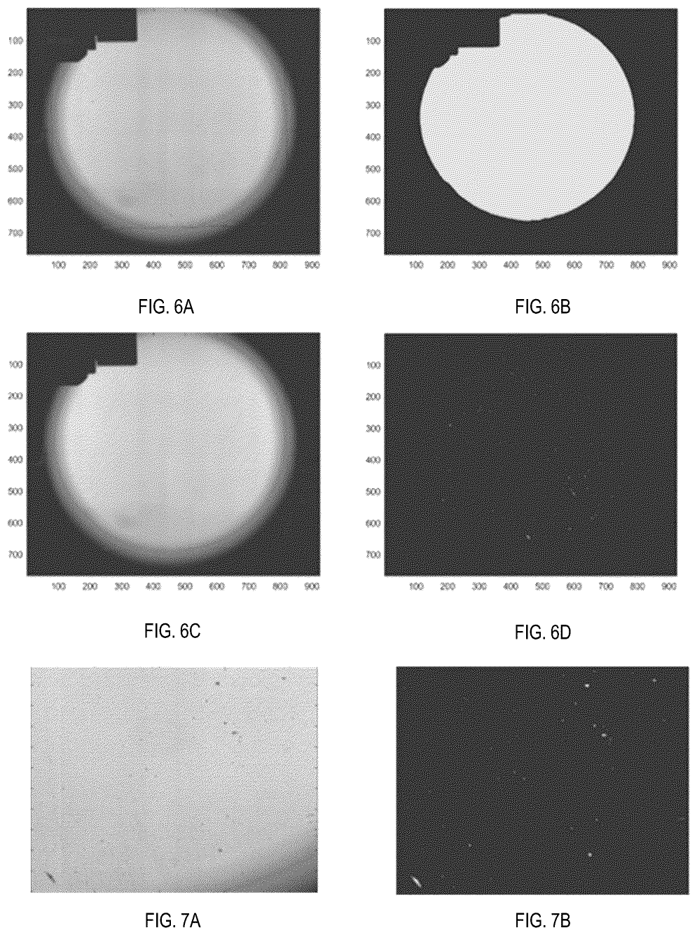

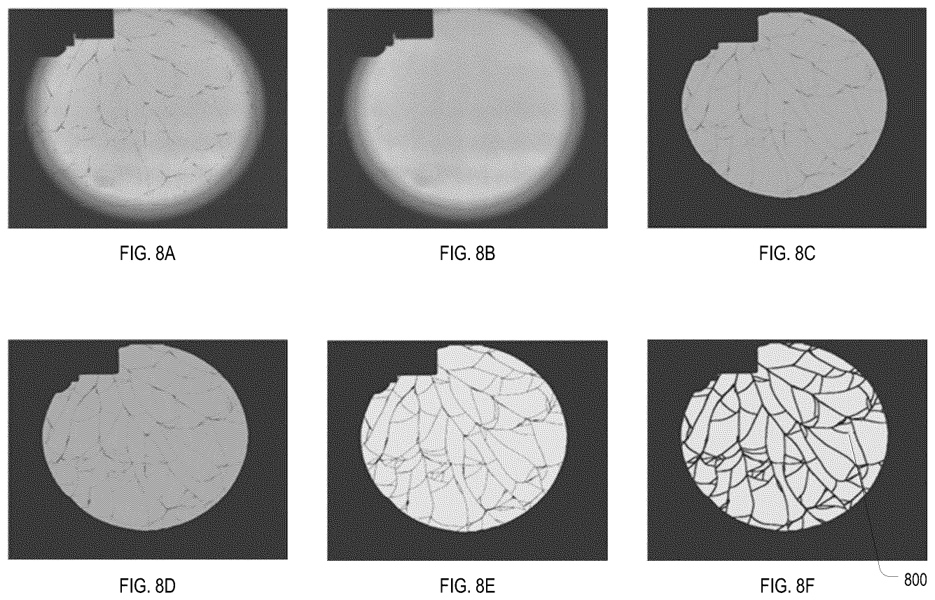

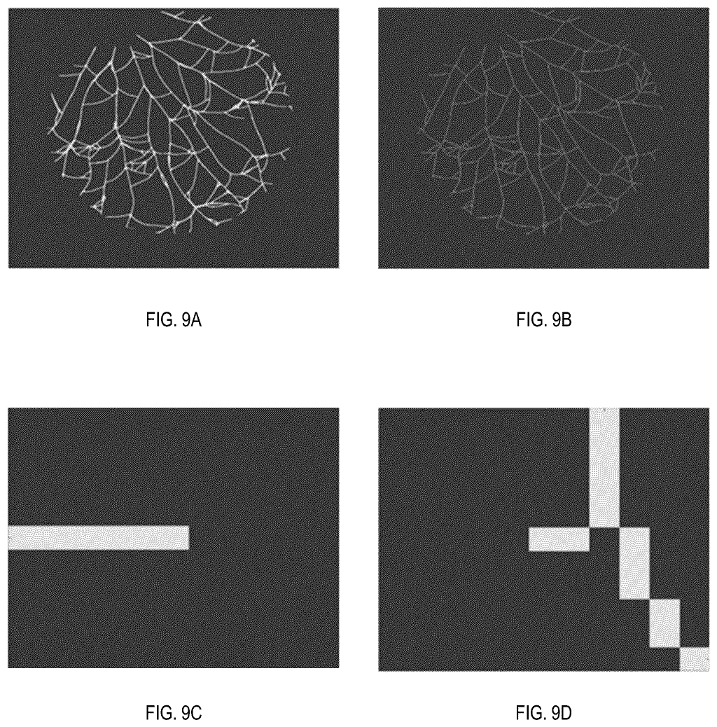

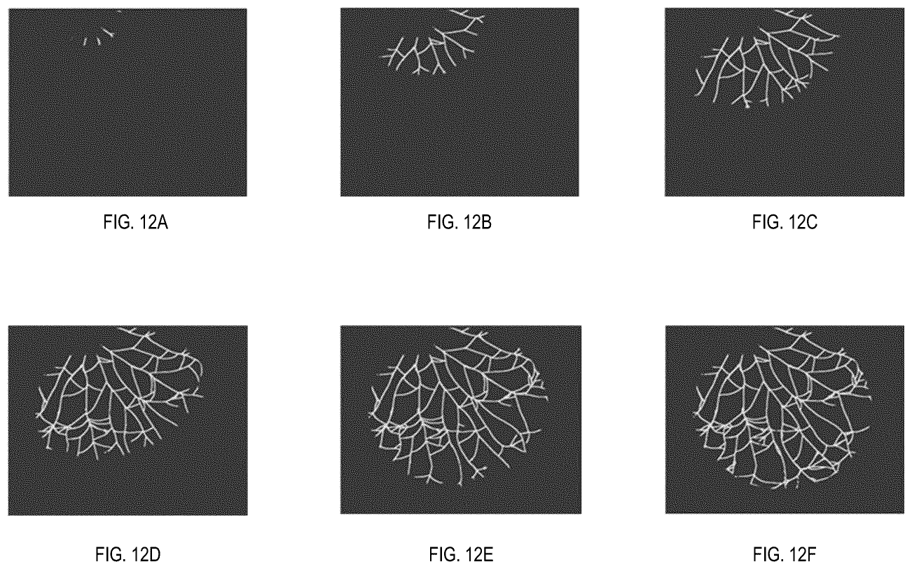

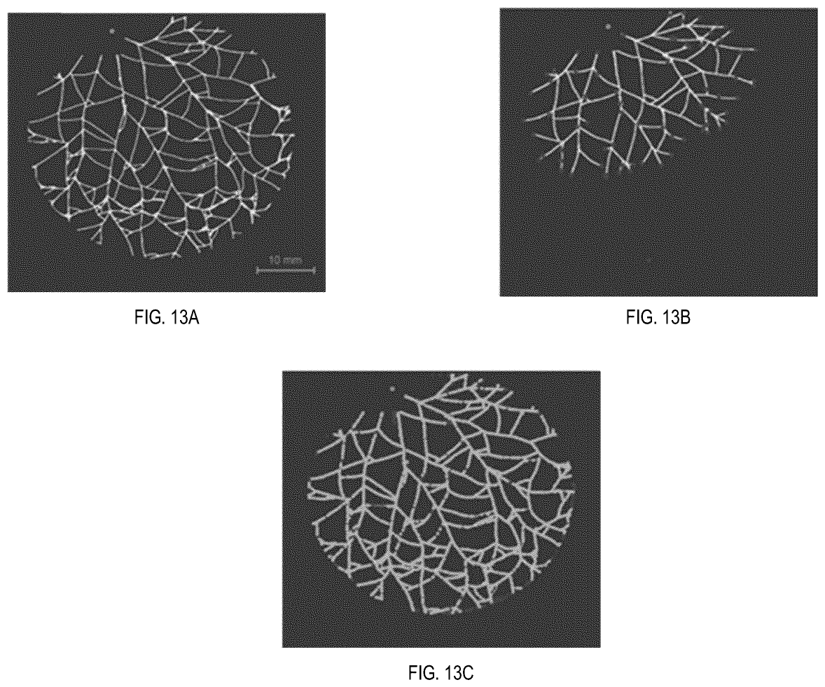

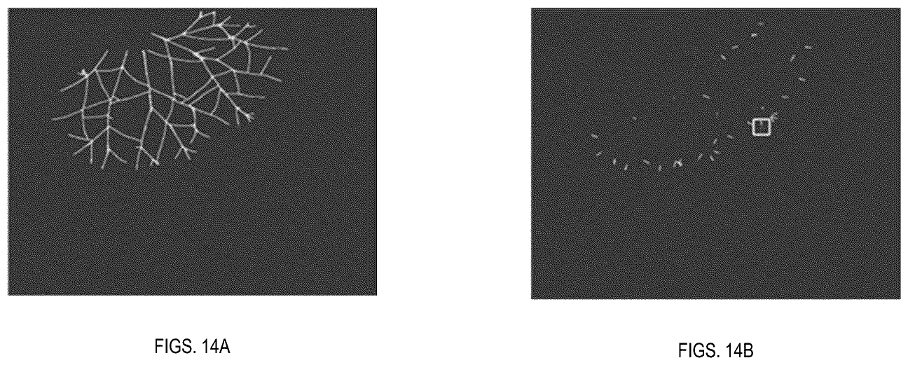

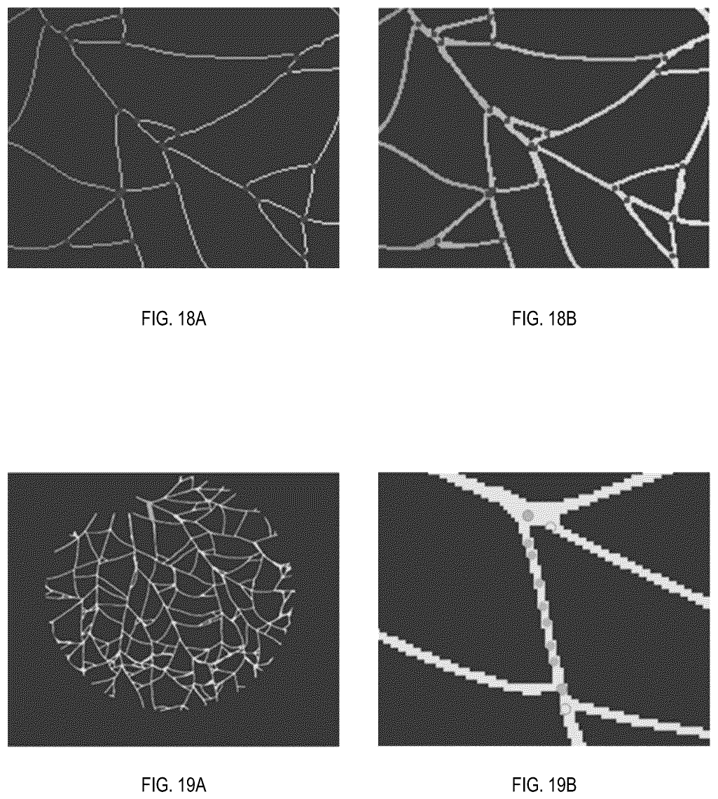

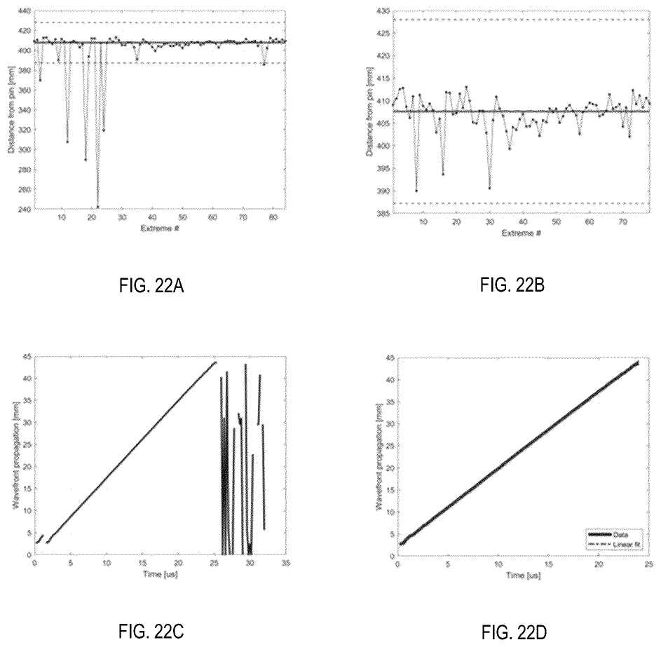

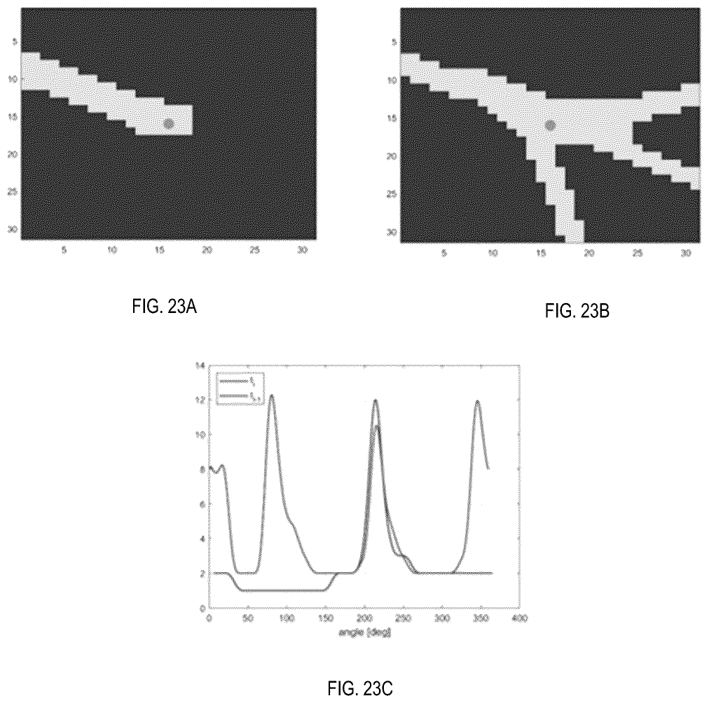

FIG. 5 is a flowchart providing an overview of methods 500 of processing and analyzing time-resolved images of crack propagation in a glass sample, in accordance with various embodiments. As illustrated, following collection of the raw image frames (step 502), as can be done using an imaging system 400 as depicted in FIG. 4, the images are post-processed (step 504) to correct for the optical response of the system 400, remove background artifacts, and/or otherwise prepare the image frames for subsequent analysis, as explained in more detail with reference to FIGS. 6A-6D and 7A-7B. A set of post-processed image at the end of the acquisition window, after the crack has completely propagated through the glass sample, can then be processed to determine the final crack structure (step 506), as explained with reference to FIGS. 8A-8D. In various embodiments, this step also involves interpolating or extrapolating crack segments to close non-physical gaps displayed in the crack structure, as explained with reference to FIGS. 9A-11B. The final crack structure may be analyzed to identify branchpoints and individual crack segments (step 508), as well as to identify and determine the properties of the individual glass fragments as well as fragmentation statistics (step 510). The time-resolved images of the acquired image sequence may be processed to determine crack extremities as a function of time (step 512), as described with reference to FIGS. 12A-13C. The resulting time-dependent extremity data, in turn, can be used to classify the branchpoints (step 514), as described with reference to FIGS. 14A-17, to distinguish between split points, delayed split points, and endpoints. The time-dependent extremity data may further be used to relate the instantaneous cracks to the identified individual cracks of the final crack structure and track crack propagation over time (step 516), as explained with reference to FIGS. 18A-20. Alternatively, for crack structures creating a very large number of fragments, the crack extremities may be analyzed collectively to determine a crack wavefront and its displacement over time (step 518), explained with reference to FIGS. 21-22D. Further analysis may be performed on the branchpoints, individual cracks, and/or wavefront to determine branching statistics and the velocity or acceleration of individual cracks or the crack wavefront (step 520), as explained with reference to FIGS. 23A-23C.

In the following, the various processing and analysis steps will be described in more detail with respect to an example embodiment that takes 180 raw image frames as input. As will be apparent to those of ordinary skill in the art, the processing can be straightforwardly adjusted to a different number of frames, and certain details described below can be modified without departing from the general principles disclosed.

### Raw Image Post-Processing

In various embodiments, the trigger and data cameras are configured such that the acquired sequence of (e.g., 180) image frames for a given glass sample includes several frames at the beginning of the sequence that precede the formation of a crack. These images can be processed to extract a mask image for defining a region to be processed in all images, and to compute corrections for non-uniformities in intensity and dust particles in the image that can subsequently be applied to the images capturing crack propagation. Dust correction is performed because, even though the data collecting procedure (as described with reference to FIG. 4B) involves vacuuming and cleaning the substrate after cracking each sample, in some instances, a small number of minute glass particles remain on the substrate and are visualized in the images of the next sample. Since these particles deflect light, they appear as black objects in a shadowgraph image. To avoid interference with the newly formed crack signal, a particle-removal step is applied to the images.

FIGS. 6A-6D are example processed images of a glass sample prior to crack formation, illustrating masking and dust correction steps in accordance with an embodiment. FIG. 6A shows the average of the first ten image frames of the sequence, where no crack is present yet. Using a suitable threshold, this averaged image is converted into a binary mask image, shown in FIG. 6B. The mask image identifies the region within the image where the light intensity is relatively uniform, as well as constrains the subsequent image analysis algorithms (e.g., for fragment recognition) to operate in a confined region, which preferably does not include the edges of the sample. Further, the averaged image of FIG. 6A undergoes a two-dimensional median smoothing, which serves to obtain a similar image, shown in FIG. 6C, that has the same intensity distribution, but where the particles have been averaged out and thus eliminated. The kernel size of the median smoothing operator is selected to be a compromise between particle elimination and a suitable preservation of intensity gradients. The original image of FIG. 6A is then normalized by the median smoothed image of FIG. 6C to remove light non-uniformities and correct for barreling effect. An interrogation region is defined in the middle of the resulting normalized image, and the mean intensity evaluated. This value is subtracted from the normalized image to obtain a new image, shown in FIG. 6D, that has only the contributions from the particles. Since the locations of the particles do not change over time, this particle image is used to correct for and remove the particles from all images in the sequence.

FIGS. 7 and 7B are zoomed-in views of the images of FIGS. 6A and 6D, showing dust present in the uncorrected image and isolated dust after identification, respectively.

### Final Crack Identification

In various embodiments, the sequence of image frames for a given glass sample includes at least several frames at the end of the sequence that follow completion of crack propagation, but precede the shattering of the glass sample and resulting displacement of the glass fragments. In these final image frames, the crack is fully formed and no longer propagating; in other words, it is “frozen in time.” Accordingly, the final image frames, which all show the same crack structure, can be processed jointly to extract the final crack structure of the sample, which can then be analyzed further to evaluate fragmentation metrics.

In some imaging systems, as a result of limitations of the employed chip technology, the camera sensitivity, and thus the intensity recorded by the camera, is not constant, but drifts over time and/or fluctuates periodically. In one implementation, for instance, a decrease in intensity over time, superposed with oscillations in intensity with a period of about ten frames, were observed. These fluctuations in intensity are corrected for, in some embodiments, to render the intensity comparable between images so as to facilitate a fixed-threshold approach to identifying the darker crack structures, as is used herein. The correction may involve normalizing each individual raw image with its own correction matrix.

FIGS. 8A-8F are example processed images of a glass sample following completion of crack propagation, illustrating the individual image normalization and extraction of the final crack structure in accordance with an embodiment. FIG. 8A shows an individual raw image of a sample with a final crack structure. This image is processed by iterative two-dimensional median smoothing performed with an increasing kernel size; FIG. 8B shows a resulting median-smoothed image. The correction matrix is determined from the media-smoothed images by choosing, as the value of the (i, j) pixel in the matrix, the maximum value among the (i, j) pixels of the median-smoothed images. This approach ensures that kernel size is not a limiting factor in the removal of cracks, while maintaining the correct intensity profiles. In the set of image frames showing the final crack structure, each image is normalized by its own correction matrix to correct for the variable camera sensitivity, as well as processed to remove the dust particle contributions as described with reference to FIGS. 6A-6D and 7A-7B. FIG. 8C shows the corrected image of the crack derived from the raw image of FIG. 8A by application of the correction matrix and dust particle removal.

Following correction of the individual images, the set of images of the final crack structure are averaged. FIG. 8D shows the average of a set of twenty image frames of the final crack structure, computed following correction of the individual images. The average corrected image is converted into a binary image, shown in FIG. 8E, by setting all pixels below a specified intensity threshold to zero. Then, an erosion step, e.g., performed using a 3×3 pixel square kernel, may be applied to artificially increase the width of the cracks, resulting in the final crack structure shown in FIG. 8F; this step may help closing unconnected cracks.

### Crack Interpolation and Extrapolation

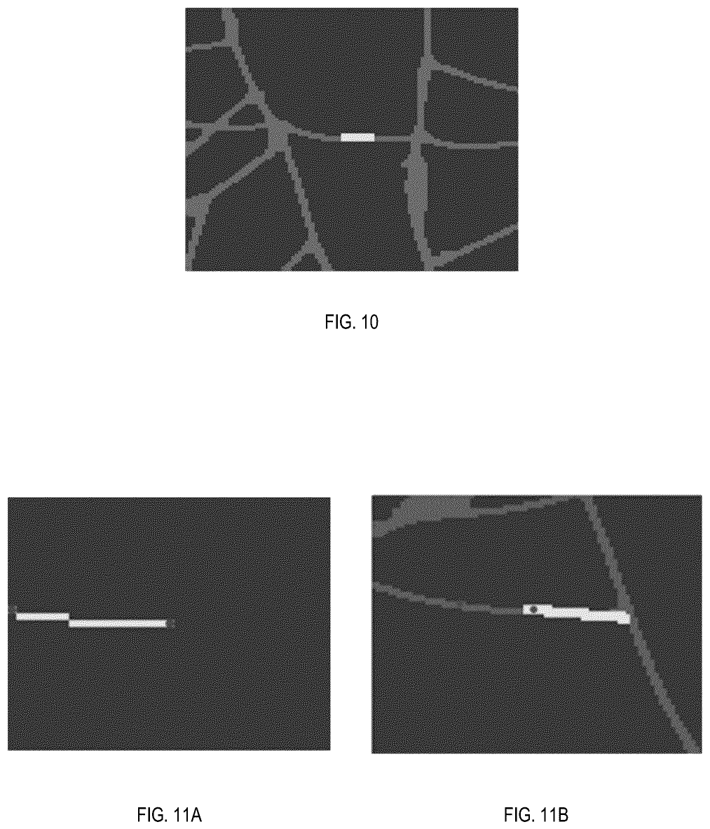

Despite the ability of the above-described algorithm to adjust and correct for differences in light intensity, the crack structure obtained following the correction, averaging, and erosion process may still include false gaps in the cracks as a result of imaging artifacts. There are, for example, instances in which the crack is aligned with respect to the collimated light in such a way that light is not sufficiently deflected and, therefore, no shadow is recorded by the detector. In these cases, the crack will show up as interrupted, displaying a gap. An example of such a gap can be seen in FIG. 8F at a location labeled 800. To improve the quality of the data for the evaluation of fragmentation statistics, the interrupted cracks may be reconnected and the gaps be closed by interpolation as described with reference to FIGS. 9A-9D and 10 and/or by extrapolation as described with reference to FIGS. 11A-11B. In some embodiments, interpolation and extrapolation are performed sequentially, with extrapolation aiming at closing gaps where the interpolation algorithm fails.

FIGS. 9A-9B and 9C-9D are example processed images of a crack structure and image kernels, respectively, illustrating crack interpolation in accordance with an embodiment. The first step involves the inversion of the binary value of the crack structure image (i.e., setting zero to one and vice versa), resulting in an image as shown in FIG. 9A, followed by the conversion of the inverted crack structure image to a “skeleton” image, shown in FIG. 9B. The skeleton image is a logical binary image where all objects of the original image have been converted to a one-pixel wide curved line without changing the essential structure of the image; creating a skeletonized crack structure extracts the centerline of the crack structure while preserving the topology. Computational tools for creating skeleton images are readily available commercially, e.g., as a built-in function in Matlab. The next step is the identification of the skeleton endpoints highlighted by red dots in FIG. 9B, and the evaluation of their coordinates. All possible pairwise distances between all the endpoints, herein also “extremities,” are evaluated. (Distances equal to zero, corresponding to the distance between the i^{th} coordinate and itself, are eliminated.) For each unique extremity, the shortest among the distances to all other extremities is found and saved in an array, reflecting the assumption that the crack propagated along this minimum distance between two close extremities.

Once the extremities and mutual distances have been determined, two extremities of a given pair are connected if they satisfy the following conditions: First, the distance between the two extremities is listed in the array determined during the aforementioned step, meaning that for at least one of the extremities, the other one is the closest. Second, the length of the cracks before the interruption is not too small when evaluated using an 11×11 pixel kernel centered on the extremity. This condition ensures that the extremity being considered is the extremity of an actual crack, and not a false positive. FIG. 9C is a kernel showing an example of an extremity that would satisfy the condition since the crack touches the edge of the kernel only at one point. FIG. 9D is a kernel showing an example of an extremity that does not satisfy the condition since the crack touches the edges of the kernel in more than one location, suggesting that what appears to be an extremity (in the center of the kernel) is an artifact associated with the larger crack to the right. The third condition is that the potential connection between the two extremities does not cross an already existing crack. If these three conditions are satisfied, then the extremities are connected. The connection is performed on the original crack structure image, not the skeletonized image. The newly obtained crack structure is then saved for additional processing. FIG. 10 is a zoomed-in portion of an example crack structure image, illustrating interpolation of a gap in a crack.

As described above, there are instances in which a crack, e.g., evaluated with an 11×11 pixel kernel, is not long enough for the software to identify it as a real crack segment. If this is the case, there may be a gap in an interrupted crack that is not closed by interpolation because one extremity does not have a corresponding second extremity to connect to. To overcome this issue, an algorithm that extrapolates gaps in cracks identified as interrupted may be used. In various embodiments, similar to crack interpolation, the first step in crack extrapolation is the conversion of the crack structure image to a skeleton structure. The second step is the identification of the skeleton endpoints and the evaluation of their coordinates. It is important to note that not all the identified extremities will be part of a matched pair, unlike for the interpolated crack algorithm. Therefore, to extrapolate the crack, the following procedure is performed, in accordance with one embodiment: A 3×3 pixel kernel is centered on the extremity coordinate, and a check ensuring that the crack touches the edge of the kernel in only one place is performed. If this condition is satisfied, the kernel size is increased by two pixels per side and the check is repeated. This iterative process continues until the condition is no longer valid. If the final kernel size that still meets the condition is greater than a minimum threshold (selected to avoid extrapolating false positives), the slope of the crack is then evaluated by differentiating the coordinates (xₑ, yₑ) of the extremity and the coordinates (xₖ, yₖ) of the point where the crack touches the edge of the kernel, according to:

$$m = \frac{{y}_{e} - {y}_{k}}{{x}_{e} - {x}_{k}}$$

Since the curvature of cracks is generally not large, the crack can be approximated as linear; therefore, a larger kernel improves the accuracy of the slope evaluation. The crack is extrapolated with slope m until another crack is reached.

FIGS. 11A and 11B are zoomed-in portions of an example crack structure image, illustrating extrapolation of a crack as described above. FIG. 11A shows the final kernel, whose size is, in this example, 37×37 pixels. The extremity and the point where the crack touches the edge of the kernel are marked by red dots in both FIG. 11A and FIG. 11B. FIG. 11B further shows, in a larger (less zoomed-in) portion of the image, the extrapolated crack portion in yellow.

### Fragment and Branchpoint Identification

Once all the detected crack gaps have been closed through interpolation and/or extrapolation, the individual fragments of the glass sample may be identified based on the final crack structure, e.g., using an object identification function as is available in Matlab. An example result of such fragment identification is shown in FIG. 2B. Further, for each fragment, the following properties may be evaluated and saved for later data analysis: fragment area, fragment perimeter length, fragment eccentricity, x and y coordinates of the fragment centroid, fragment major and minor axes length.

In addition, the final crack structure may again be converted into a skeleton structure and used to identify all the branchpoints, namely the locations where a single crack splits or connects to another one. These coordinates are also saved for later post-processing.

### Crack Propagation Evaluation and Extremities Conditioning

In various embodiments, the acquired time sequence of image frames is processed to evaluate the coordinates of the propagating crack extremities as a function of time, which in turn facilitates measurements of crack propagation velocity and acceleration. To obtain the time-dependent crack extremity coordinates, each image in the sequence is normalized to correct for variations in camera sensitivity and for dust particles, as explained above (in particular with reference to FIGS. 8A-8C). The crack structure is then binarized and isolated using an appropriate threshold, converted into a skeleton structure, and the extremes of the skeleton structure are evaluated and gaps in the crack structure are closed using the previously described interpolation/extrapolation algorithms. The results are then saved. In particular, the coordinates of the identified crack extremities in each frame or time step may be stored in a crack extremity array as a function of time or frame. If the temporally resolved crack data for each glass sample includes 180 image frames acquired at a frame rate of 5 MHz, crack propagation is evaluated in 200 ns increments over a total time period of 32 μs, not including the last twenty frames of the sequence (corresponding to 4 μm), which may be processed to identify the final crack structure, as discussed above.

FIGS. 12A-12F are example processed images of a glass sample, showing the temporal evolution of a crack during crack propagation. The identified crack extremities are highlighted in red. Note that, as shown, some red dots may erroneously be placed on the body of the crack, and not just on the actual extremities.

The erroneous crack extremity identification can result from noise related to variations in the recorded camera intensity. As previously mentioned, in one implementation, the intensity was observed to decreases over time and oscillate with a period of approximately ten frames. These oscillations are related to the detector chip readout, and it was further observed that the image noise periodically surges with the same frequency. With shadowgraph approach to illuminating the glass samples and a thresholding-based approach to detect the cracks, as used herein, measurement noise derives from the inability of the adaptive thresholding to adequately compensate for variations in contrast between crack and background, which translates into false detection of crack extremities. When determining the final crack structure, averaging or median smoothing can be used to eliminate image noise; however, these techniques cannot be implemented on an individual frame in a time-resolved sequence. In accordance with one embodiment, therefore, a different technique is used to condition the time-resolved data by post-processing extremities to remove noise-induced false positives as much as possible, thereby improving the accuracy of velocity and acceleration measurements.

FIGS. 13A-13C are crack structure images illustrating crack extremities conditioning in accordance with one embodiment. FIG. 13A shows an example binary image of a final crack structure (herein also referred to as “final crack mask”), whereas FIG. 13B shows an example binary image of an instantaneous crack structure. The identified extremities are marked in the instantaneous crack structure with red dots. A green dot indicates the location where the crack was initiated, such as the impact point of the in pin onto the glass sample. The field of view is circular because of the shape of the illuminated region.

In one embodiment, crack extremities conditioning involves a sequence of steps, as described in detail in the following. While it may be possible to omit one or more of these steps in some instances, going through all steps will generally result in the best performance, as those of ordinary skill in the art will appreciate. The post-processed image frames, of which FIG. 13B provides an example, are loaded. At this step, it is also determined when in time, and in which image frame, the crack or cracks first enter the field of view. This determination is important because the time and frame of cracks appearing in the field of view is not constant and predeterminable, but varies between glass samples, because of the variable delay between impact of the pin on the glass sample and the beginning of crack propagation as well as the use of a circular buffer to record the images.

In the second step, the loaded images are processed to remove all crack segments that are not connected to the final main crack structure and whose length is below a predetermined threshold. These crack segments are typically small cracks that are propagating from the sample edge inwards at the very end of the temporal acquisition window.

The third step involves temporal filtering. For each time step, the positions of all identified crack extremities are checked against the final crack structure binary image, and those extremities which do not coincide with the final crack structure are assumed to be noise-induced erroneous extremities and are removed. FIG. 13C shows all the detected extremities over time that fall onto the final crack mask in cyan, and all the outliers, which are removed in step three, in red.

In the fourth step, any duplicates of extremity coordinates that have been detected multiple times at different time steps are removed. To this end, the crack extremity array is scanned backwards in time, and if the same pair of coordinates is detected more than once, only the earliest pair of coordinates is kept. The removal of repeated data points ensures proper temporal tracking for velocity and acceleration measurements.

In the fifth step, extremity coordinates are consolidated. For a given time step, extremes that lie on the final crack mask and are a one-pixel distance apart are considered the same extremity, and are therefore consolidated into one extremity since only one extreme per crack tip can exist.

In the sixth step, egregious extremity positions are removed using temporal filtering. Any detected extremity, given the specific time step and an average crack propagation velocity, that is realistically too far from the impact point is removed. For this purpose, it is assumed that the propagation happens radially from the impact point with a maximum velocity threshold of 5 mm/μs. An example of such an outlier can be seen in FIG. 13B, which shows an isolated red dot at the bottom of the image that constitutes a mistakenly identified extremity.

In the last step, following all data conditioning, the time and frame corresponding to the start of crack propagation is reevaluated.

### Branchpoint Analysis

In some embodiments, the processed time sequence of images, and in particular the extracted time-dependent crack extremity data, is used to classify the branchpoints in the crack structure, i.e., the locations where two or more cracks are joined. Branchpoints generally fall into three categories: locations where branching occurs instantaneously (herein called “split points”), locations where crack propagation temporarily halts and branching happens after a delay (herein called “delayed split points”), and locations where a crack ends its propagation upon running into an existing crack (herein called “endpoints”). By determining when each branching event occurred and relating identified branchpoints to the time-dependent crack extremities to determine when a branchpoint was first reached, it is possible to discriminate between these different classes of branchpoints.

In one embodiment, branchpoint analysis involves, as the first step, the identification, in all instantaneous crack skeleton images, of all the coordinates where a branching occurs. To that end, each instantaneous binary image is multiplied by the final binary crack mask image to remove any spurious features. Any detected branchpoint coordinates, and the time step at which they first appear, are saved in a branchpoint array, and any duplicates are removed.

In the second step, the branchpoint coordinates of the final skeleton image are shifted to match coordinates of the crack extremity array. For that purpose, the coordinates of all the detected propagating extremities, for all time steps, are collated in a single array. The branchpoint coordinates of the final crack skeleton image are then compared against the coordinates of the collated extremity array. When overlap happens, the overlapping coordinates are saved as the actual branchpoint coordinates; in the absence of overlap, the coordinates of the extremity closest to the original branchpoint are taken as the (shifted) branchpoint coordinates. The shifting of branchpoint coordinates accounts for the fact that the detected branchpoint coordinates do not necessarily always coincide with detected extremity coordinates and that the branchpoint coordinates in the final crack structure do not necessarily coincide with the instantaneous branchpoint coordinates, and establishes a common coordinate reference for subsequent steps.

In the third step, the branchpoints identified in the instantaneous skeleton images are related to the propagating extremities of the instantaneous images. Again, the identified branchpoints are compared against the collated extremity array, here on a step-by-step basis. If a spatial overlap is found, the matching extremity coordinates are also saved as a branchpoint; otherwise, the extremity coordinates closest to the branchpoint are saved instead. Relating the branchpoints to the propagating extremities serves to determine when, in time, a crack reaches a specific branchpoint; without spatially matching propagating extremities and branchpoints, this information would not be known.

The fourth step is a filtering step to remove any duplicates and any detected branchpoints that do not appear in the final crack structure, as evaluated based on a distance threshold.

Once all the branchpoints have been determined, the fifth step is the classification of each individual branchpoint as a split point where the branching occurs without delay as the crack reaches and crosses the branchpoint coordinates, a delayed split point where the branching occurs after a random delay, or an endpoint where, at a prior crack extremity of one crack, another crack ends its propagation. An example process for determining branchpoint classifications will be described in the following with reference to FIGS. 14A-17. As will be understood by those of ordinary skill in the art, some of the described steps may be altered or omitted while still allowing for branchpoint classification.

The classification may begin with collating all pre-processed, “shifted” branchpoints in a single array. Then the algorithm loops over the array and performs various operations and validity checks for each branchpoint. Denoting a given branchpoint as the i^{th} branchpoint and its coordinates as (xᵢ, yᵢ), the crack extremity array is first scanned to determine when in time the crack reached the location coincident with the i^{th} branchpoint. This time will be called t₁. FIG. 14A is an example instantaneous crack structure image with a red dot identifying the location of a branchpoint of interest just reached by the propagating crack.

Next, the time when the actual branching occurs is determined. In some embodiments, this involves creating for each time step j, starting from t₁ and until after detection of branching (possibly up to the end of the image acquisition), a temporary image by subtracting, from the instantaneous crack structure image at tⱼ, the instantaneous crack structure image at an earlier time t=tⱼ−Δt, where Δt corresponds to a small integer multiple of the interval between two successive frames; in one example, the interval between successive frames is 0.2 μs, and Δt=0.6 μs. The subtraction is performed to isolate small crack sections and to make sure that the current crack of interest is not connected to any of the other crack segments. FIG. 14B is an example difference image between the crack structure image of FIG. 14A and an earlier image. An object identification routine is run on this difference image, and all the crack segments not connected to the branchpoint of interest are eliminated. The white box in FIG. 14B indicates a region surrounding the branchpoint of interest, which is analyzed over a sequence of time steps j until branching is detected at the branchpoint.

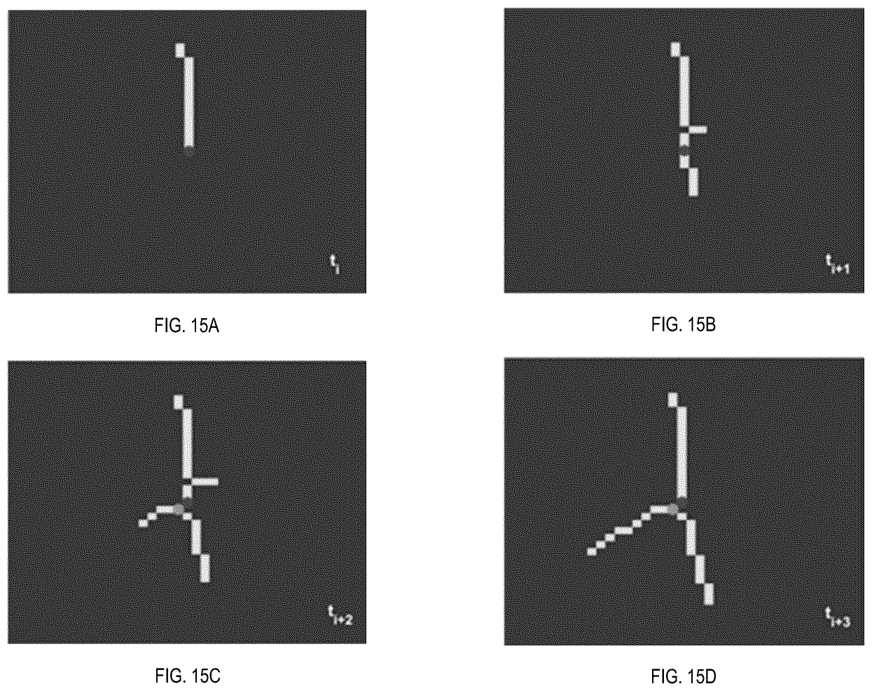

FIGS. 15A-15BD are zoomed-in views, corresponding to the region inside the white box surrounding the branchpoint of interest, of difference images computed for a sequence of time steps as part of determining the time of first branchpoint occurrence. For each image, the isolated crack segment is converted into a skeleton structure, and a branchpoint identification is performed. Whenever a branchpoint is detected, the time at which it occurs, which will be called t₂, is saved, and a sequence of checks is then performed to verify the validity of the result. FIG. 15A shows the time step when the propagating crack first reaches the coordinate of the branchpoint of interest (red dot). FIG. 15B shows the successive time step, with the crack continuing its propagation and no branchpoint yet being detected. Finally, FIG. 15C shows the first time instance when the branching is detected (green dot). FIG. 15D shows the time step after the first detection of branching. Note that, as mentioned earlier, the instantaneous branchpoint (green) does not perfectly align with the branchpoint determined from the final crack structure (red).

Following the detection of the branchpoint, a sequence of checks may be performed to verify its validity. The first validity check may repeat the image subtraction, but now considering the instantaneous images at t₂+0.2 μs and t₂−0.6 μs. If the branchpoint is still present at the time step after the initial detection, that suggests that the original detection was not likely caused by a spurious crack. The second check compares the location of the instantaneous branchpoints determined at t=t₂ and at t=t₂+0.2 μs, e.g., as shown in FIGS. 15C and 15D, respectively. If the distance between the two branchpoints is less than two pixels, they are considered the same branchpoint and the next check is enabled. The final check ensures that the verified branchpoint coincides with the original i^{th} value from the collated array. Coincidence is satisfied if the distance between branchpoints is less than two pixels. If all three checks are passed, the time separation between t₁ and t₂ is evaluated; if (t₂−t₁)<0.6 μs, the generation of the new crack may be considered instantaneous and the branchpoint be saved as a split point; otherwise, the coordinates of the branchpoint are saved into a temporary array for later processing. Additionally, if the time separation is too large, e.g., (t₁−t₂)≥10 μs, the coordinates are considered missed and saved in the temporary array for later processing.

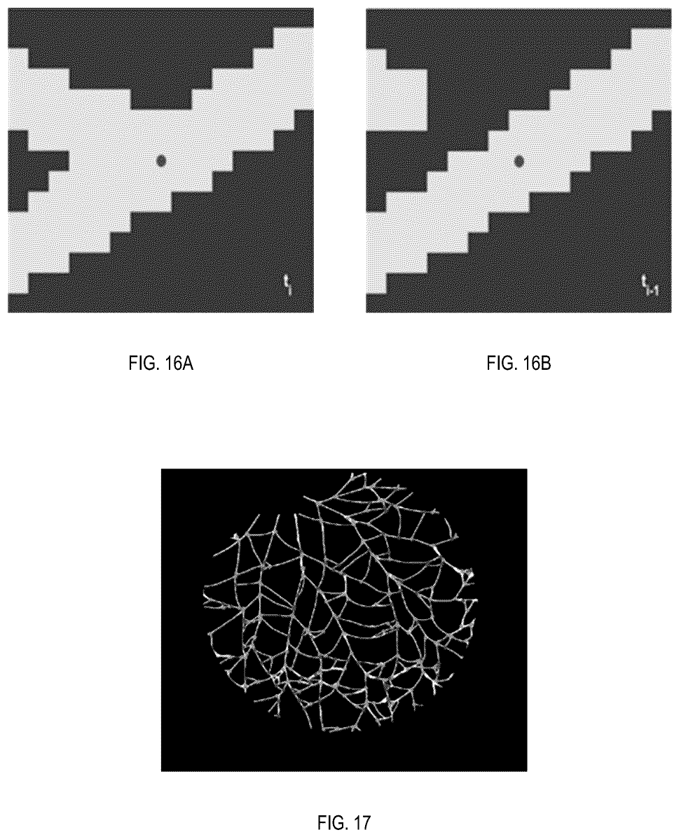

All the detected branching points that have not been labeled as split points (where branching is instantaneous) are assumed to be either delayed split points or endpoints-which one is determined by further processing. Considering the i^{th} uncategorized branchpoint with coordinates (xᵢ, yᵢ), the images of the instantaneous cracks at tᵢ=t₂ (the time when branching was detected) and tᵢ₋₁=t₂−0.2 μs are considered. For each of the two images, a 10×10 pixel square interrogation region is created centered around (xᵢ, yᵢ). An object identification function is then used to count the number of objects in each interrogation region. If there is only one object at t=tᵢ, but there are two objects at t=tᵢ₋₁, that means that the crack is ending its propagation at the considered branchpoint; therefore it is labeled as an endpoint. FIGS. 16A and 16B illustrate this case with square kernels surrounding a branchpoint in images at t=tᵢ and t=tᵢ₋₁, respectively. If the number of objects is one in both images, the length scale of the interrogation region, or kernel, is iteratively increased, e.g., by two pixels at the time, and the object counting is repeated. The iterative process continues until two objects are detected at t=tᵢ₋₁, or the length scale of the interrogation region reaches a specified threshold, such as twenty pixels. The iterative sizing of the interrogation region is done to ensure that no endpoint identification is missed because of limited kernel size. If the i^{th} branchpoint is not identified as an endpoint, it is then categorized as a delayed split point.

FIG. 17 is a processed image of an example crack structure with branchpoints color-coded to indicate the classification as determined with the above-described procedure. Instantaneous split points are shown as green dots, delayed split points as orange dots, and endpoints as red dots.

### Individual Crack Identification and Crack Displacement Tracking

In some embodiments, the final crack structure of a glass sample is analyzed, based on the identified branchpoints, to further identify individual cracks, which in turn allows extracting crack-specific statistics. To this end, a binary image of a final crack structure, e.g., as shown in FIG. 13A, may first be converted into a skeleton structure. Then, all pixels in a suitable kernel (e.g., a 3×3 kernel) centered on the location of the known branchpoints are set to zero, which has the effect of separating and isolating each individual crack segment (also simply “crack”) of the overall crack structure from the other segments. An object identification routine can then be used to identify and label each individual crack. After the individual one-pixel-wide cracks have been identified in the skeleton structure, the cracks can be extended, in an additional processing step, to all pixels of the original crack structure, which generally has a line thickness greater than one pixel. For this purpose, each crack segment of the skeleton structure is considered and its coordinates are evaluated; then, all the neighboring pixels in the original inverted crack structure image that have a value of 1 (the pixel value of the binary crack mask) are found. If such pixels are connected to the crack segment in question, their value is changed from a to match the value identifying the respective skeleton segment. The process is iterated until no more connected pixels are found. In this manner, all pixels of a given crack are assigned the same label, or value, as the skeleton segment that overlaps them. FIGS. 18A and 18B are portions of an example skeleton structure and corresponding crack structure, respectively, color-coded to visually distinguish between individual cracks identified in this way. The red dots indicate the locations of branchpoints.

With individual cracks being identified in the final crack structure, the time-resolved coordinates of the propagating crack extremities, e.g., determined as described above with reference to FIGS. 12A-13C, may likewise be assigned to specific cracks, which then allows evaluating the displacement of each individual crack as a function of time. For a given crack segment, all the time-resolved crack extremities that spatially overlap with the specific crack segment are saved in an array, alongside the time at which each extremity first appears. As will be appreciated, this data allows computing, for example, the velocity with which the tip of a propagating crack segment moves. The branchpoints associated with the specific crack, that is, the beginning and ending coordinates of the crack, may be identified and saved as well.

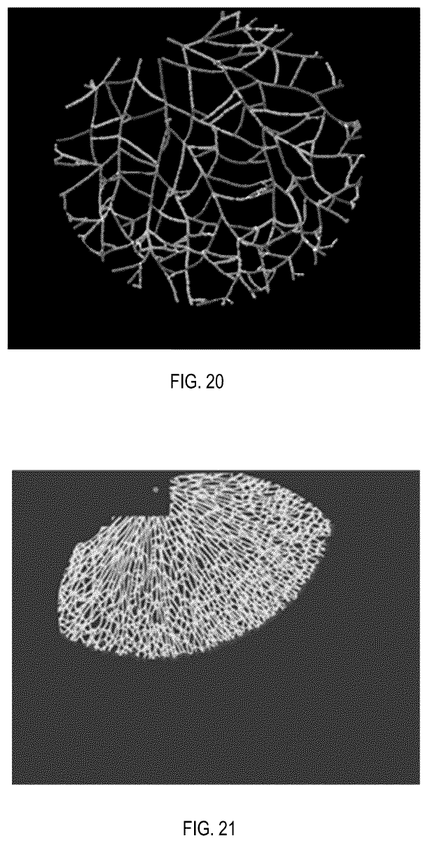

FIG. 19A is an example processed image of a crack structure, showing the coordinates of a specific crack superimposed in cyan. FIG. 19B is a zoomed-in view of FIG. 19A, in which the individual crack extremity coordinates along the specific crack can be discerned. The branchpoint coordinates are identified by the red circles. FIG. 20 shows the crack structure of FIG. 19A with all the various crack extremities superimposed, separated and labeled by different colors based on the crack they belong to.

### Wavefront Displacement Tracking

Highly fragmented samples, where the high fragment density resulted in cracks whose propagation is described by just a few data points (due to the finite spatial and temporal imaging resolution), are generally not amenable to the above-mentioned measurements of individual crack displacements, and are therefore processed differently, in accordance with some embodiments. Specifically, if there are not enough data points available for accurate mean velocity and acceleration measurements of individual cracks, the propagation of the crack front, which is composed of many extremities, can be tracked instead. Since the crack segments in highly fragmented samples are relatively small, their propagation mainly follows a radial direction with respect to the impact point. Tracking the wavefront displacement as a function of time thus provides an estimate of the average crack propagation speed.

FIG. 21 is an example processed image of a highly fragmented sample at some time during crack propagation, illustrating an extremities wavefront. The impact point is indicated by a green dot, and the detected extremities are shown by red dots. As can be seen from FIG. 21, some of the detected extremities do not belong to the propagating wave front. Of these outliers, some lie on the edges of the circular mask, while others are located within the overall crack structure.

FIGS. 22A-22D are plots illustrating wavefront displacement measurements in accordance with an embodiment. For each time step in the image sequence, the extremities of the instantaneous crack structure image are considered, and their distance from the impact point is evaluated. To eliminate the outliers, the median of all extremity distances from the impact point is calculated, and any distance that falls outside specified thresholds surrounding the median value, e.g., under 95% or above 105% of the median value, is then removed. An example plot of the extremity distances from the impact point for a single time instance, overlaid with their median value (red line) and ±5% margins (dashed lines) is shown in FIG. 22A. After this first data filtering step, the median is re-calculated, and an average distance is obtained by dividing its value by the pixel resolution. An example plot of the extremity distances from the impact point after outlier removal is shown in FIG. 22B; the updated median value indicated by a green dashed line. The removal of outliers and re-calculation of the median extremity distance is repeated for all the images in the sequence, and the median extremity distance, or wavefront displacement, is then plotted as a function of time, as illustrated in FIG. 22C. Finally, any data point preceding the first image with detected extremities is eliminated. Further, the propagation array is differentiated, and any data point whose absolute difference is above a specified threshold (e.g., 1.5 mm) is also removed, which serves to remove noisy and oscillatory behavior as can be seen beyond ˜25 μs in FIG. 22C. The noisy behavior generally happens after the crack has completed its propagation through the sample, and is caused by noise-induced false extremity detection. The final filtered data is shown in FIG. 22D. A linear fit (red dashed line) is applied to the data (blue line), and the gradient of the fit is taken as the average value of the propagation velocity. Note that, as reflected in the linearity of the plot, the acceleration of the front is zero.

### Branching Angles and Crack Propagation Analysis

In some embodiments, the crack structure is further analyzed to count the number of cracks that are formed upon branching, measure the propagation directions of these newly formed cracks relative to the incoming track, and measure the velocities and accelerations of cracks departing from or ending in branchpoints.

FIGS. 23A-23C illustrate an example iterative process for quantifying the branching angles, in accordance with an embodiment. In the first step, an interrogation kernel, e.g., a 31×31-pixel kernel, is centered on the j^{th} branchpoint. This kernel is applied to the binary crack propagation images at tᵢ₋₁ (the frame immediately before the branching happens) and t_{f} (the final frame after the crack propagation has ended), as shown in the example kernel images depicted in FIGS. 23A and 23B, respectively. The orange dot at the center of each kernel indicates the branchpoint. Consideration of the final frame accounts for both branching and delayed branching events. The second step, if needed, involves the removal of secondary cracks that are not connected to the crack passing through the considered branchpoint in the kernel images at tᵢ₋₁ and t_{f}, and this step is generally needed only for the initial large kernel sizes. In the third step, the cleaned-up kernel images are converted into one-pixel-wide skeleton structures. The branchpoint in the skeleton structure is re-evaluated, and if multiple branchpoints are detected, only the one closest to the center of the kernel is kept.

The fourth step involves a 360° scan of the two kernel images centered on the branchpoint coordinate determined in the third step. At an angular position q, the radius will cross pixels that are either 0 (where no crack is present) or 1 (where a crack is present). The values of all the pixels along the q direction are summed up. FIG. 23C shows the results of this analysis for the kernel of FIG. 23A (before branching) in red and for the kernel of FIG. 23B (after branching) in blue. In the fifth step, the peaks of the curves representing the pixel sums as a function of angle, as shown in FIG. 23C, are identified; these peaks indicate the angles of the individual branches of the crack structure at the considered branchpoint. In general, the shape of the cracks at tᵢ₋₁ and t_{f} is not necessarily the same, and therefore, the peaks are not always perfectly aligned with each other. If they are not, a relative shift may be applied to align the peaks. The angular direction of the incoming crack (corresponding to the single red peak in FIG. 23C) is then set to zero, and the angles of the peaks determined from the image at t_{f} (corresponding to the blue peaks in FIG. 23C), or the angular distance between pairs of the peaks, are evaluated; these angles and angular distances correspond to the angular locations of and the angular separations between all the crack branches.

In a sixth step, several verification checks of the previously obtained results are performed. If the number of objects in the kernel is greater than one, the kernel size may be reduced by two pixels, and the first through fifth steps may be repeated. If the number of detected branches is less than three (meaning that there is no branching), no objects are detected in the kernel, or the kernel size is below a threshold, the routine is interrupted and moves to the next branchpoint. If only one object as well as separate unique local maximum are detected, the value of the angular separation is saved, and the routine moves to the next branchpoint.

After the algorithm has analyzed all the branchpoints detected in a sample, the results may be sorted based on the number of branches (e.g., 3, 4, 5, etc.). Calculating the angle of a crack ending as it propagates into an existing crack is performed in a similar way.

The velocity and acceleration of a crack extremity as it departs a branching point or as it ends at an endpoint may be evaluated for cracks for which more than three propagation data points are available. Denoting the branchpoint coordinates and time of branching with (x_{br}, y_{br}) and t_{br}, respectively, and the coordinates of a crack extremity two time steps later (i.e., at t_{br+1}) with (x_{br+2}, y_{br+2}), the branching velocity v_{br} can be evaluated according to:

$${v}_{br} = \frac{\sqrt{{{x}_{br + 2} - {x}_{br} )}^{2} + {( {y}_{br + 2} - {y}_{br} )}^{2}}}{{t}_{br + 2} - {t}_{br}}$$

Similarly, denoting the endpoint coordinates of a crack (that is, coordinates of the point where the crack merges with another crack) and the associated time of merger with (xₑₙ, yₑₙ) and tₑₙ, respectively, and the coordinates of the crack extremity two time steps earlier (i.e., at tₑₙ₋₂) with (xₑₙ₋₂, yₑₙ₋₂), the endpoint velocity v_{br} can be calculated according to:

$${v}_{en} = \frac{\sqrt{{{x}_{en} - {x}_{en - 2} )}^{2} + {( {y}_{en} - {y}_{en - 2} )}^{2}}}{{t}_{en} - {t}_{en - 2}}$$

Two time steps may be used to improve the spatial and temporal accuracy of the measurement. Branching and endpoint accelerations a_{br}, aₑₙ can be calculated as follows:

$${a}_{br} = \frac{{v}_{br + 2} - {v}_{br + 1}}{{t}_{br + 2} - {t}_{br + 1}}$$

$${a}_{en} = \frac{{v}_{en - 1} - {v}_{en - 2}}{{t}_{en - 1} - {t}_{en - 2}}$$

### Data Processing System

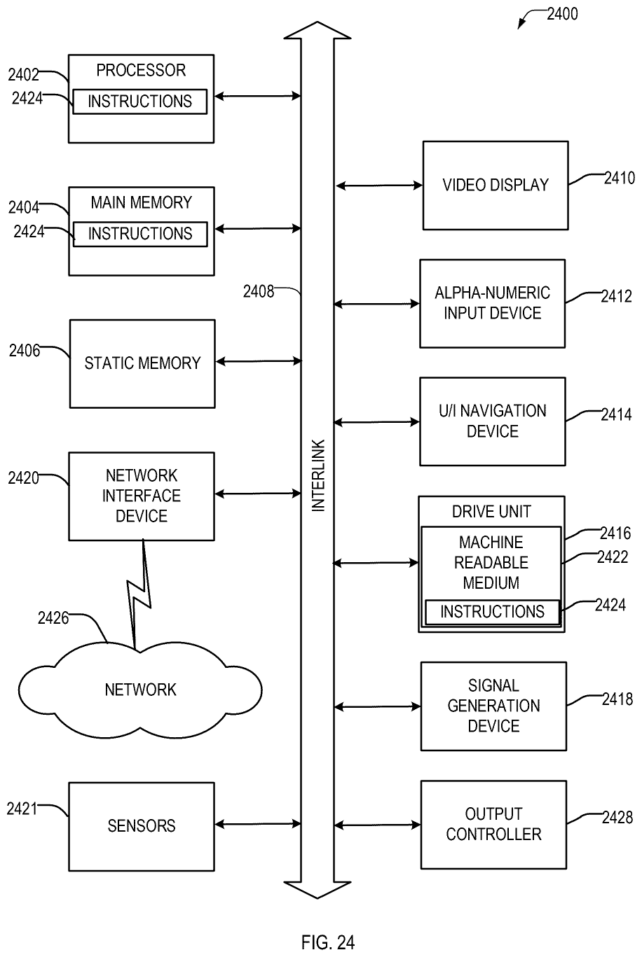

FIG. 24 is a block diagram of an example machine 2400 upon which any one or more of the data processing techniques discussed herein (e.g., with reference to FIGS. 5-23C) may perform. In alternative embodiments, the machine 2400 may operate as a standalone device or may be connected (e.g., networked) to other machines. In a networked deployment, the machine 2400 may operate in the capacity of a server machine, a client machine, or both in server-client network environments. In an example, the machine 2400 may act as a peer machine in peer-to-peer (P2P) (or other distributed) network environment. The machine 2400 may be a personal computer (PC), a tablet PC, a personal digital assistant (PDA), a smartphone, a web appliance, a server computer, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Machine (e.g., computer system) 2400 may include a hardware processor 2402 (e.g., a central processing unit (CPU), a graphics processing unit (GPU), a hardware processor core, or any combination thereof), a main memory 2404 and a static memory 2406, some or all of which may communicate with each other via an interlink (e.g., bus) 2408. The machine 2400 may further include a display unit 2410, an alphanumeric input device 2412 (e.g., a keyboard), and a user interface (UI) navigation device 2414 (e.g., a mouse). In an example, the display unit 2410, input device 2412 and UI navigation device 2414 may be a touch screen display. The machine 2400 may additionally include a storage device (e.g., drive unit) 2416, a signal generation device 2418 (e.g., a speaker), a network interface device 2420, and one or more sensors 2421, such as a global positioning system (GPS) sensor, compass, accelerometer, or other sensor. The machine 2400 may include an output controller 2428, such as a serial (e.g., universal serial bus (USB), parallel, or other wired or wireless (e.g., infrared (IR), near field communication (NFC), etc.) connection to communicate with or control one or more peripheral devices (e.g., the data camera 410 and trigger camera 412, a printer, card reader, etc.).

The storage device 2416 may include a machine-readable medium 2422 on which are stored one or more sets of data structures or instructions 2424 (e.g., software) embodying or utilized by any one or more of the techniques or functions described herein. The instructions 2424 may also reside, completely or at least partially, within the main memory 2404, within static memory 2406, or within the hardware processor 2402 during execution of the instructions by the machine 2400. In an example, one or any combination of the hardware processor 2402, the main memory 2404, the static memory 2406, or the storage device 2416 may constitute machine-readable media.

While the machine-readable medium 2422 is illustrated as a single medium, the term “machine-readable medium” may include a single medium or multiple media (e.g., a centralized or distributed database, and/or associated caches and servers) configured to store the one or more instructions 2424. The term “machine-readable medium” may include any medium that is capable of storing, encoding, or carrying instructions for execution by the machine 2400 and that cause the machine 2400 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine-readable media may include non-transitory machine readable media. In some examples, machine-readable media may include machine-readable media that are not a transitory propagating signal.

The instructions 2424 may further be transmitted or received over a communications network 2426 using a transmission medium via the network interface device 2420. The machine 2400 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 2420 may include one or more physical jacks (e.g., Ethernet, coaxial, or phone jacks) or one or more antennas to connect to the communications network 2426. In an example, the network interface device 220 may include a plurality of antennas to wirelessly communicate using at least one of single-input multiple-output (SIMO), multiple-input multiple-output (MIMO), or multiple-input single-output (MISO) techniques. In some examples, the network interface device 2420 may wirelessly communicate using Multiple User MIMO techniques.

Examples, as described herein, may include, or may operate on, logic or a number of components, modules, or mechanisms (all referred to hereinafter as “modules”). Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Described herein have been systems and methods for acquiring and processing time-resolved images of cracks propagating through glass samples that can provide an unprecedented amount of empirical data characterizing glass cracking and fragmentation. Important and beneficial aspects of various embodiments include the ability to visualize crack propagation phenomena by utilizing an appropriate illumination strategy, a unique method triggering the data camera, and software-based correction for varying image intensity, along with software-implemented algorithms for processing the images to extract measurements of final crack attributes (e.g., length, angle, etc.), final fragment attributes (e.g., location, size, shape, aspect ratio, etc.), instantaneous and average crack velocities and accelerations, crack branching sequencing and types, along with branching, crack, and fragmentation statistics.

While the invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. An imaging system comprising:
a support for placement of a glass sample thereon;
a light source configured to illuminate the glass sample;
a crack initiator mechanism comprising a movable pin configured to be substantially perpendicular to the glass sample upon impact;
a triggering camera configured to generate, responsive to detection of a crack in the glass sample, a trigger signal; and
a high-speed data camera to capture light transmitted through the illuminated glass sample in a shadowgraph configuration, the high-speed data camera comprising memory configured as a circular buffer that ceases to overwrite frames responsive to the trigger signal.

2. The system of claim 1, wherein the support is a transparent substrate.

3. The system of claim 1, wherein the movable pin is: (i) positioned to impinge on the glass sample in a corner region of the glass sample; or (ii) is adjustable in height.

4. The system of claim 1, wherein the light source is: (i) configured to illuminate the glass sample perpendicularly with collimated, monochromatic light; or (ii) comprises a light-emitting diode (LED) and an iris configured to increase spatial coherence of light emitted by the LED and to collimate the light into a parallel beam illuminating the glass sample; or (iii) light source emits in a blue wavelength region and is configured to illuminate the glass sample with collimated, monochromatic light

5. The system of claim 1, wherein:
the data camera has a frame rate of at least 5 MHz; or
the circular buffer is sized to store frames covering a time period of at least 25 μs; or the trigger camera is configured to generate the trigger signal within 12 μs of onset crack formation in the glass sample.

6. A method comprising:
placing a glass sample on a support;
illuminating the glass sample;
capturing shadowgraph images of the glass sample with a high-speed data camera configured to cyclically store the captured images in a circular buffer;
initiating a crack in the glass sample; and
detecting the crack in the glass sample with a trigger camera configured to generate a trigger signal responsive to detection of the crack,
wherein the trigger signal causes the data camera to cease overwriting frames in the circular buffer.

7. The method of claim 6, wherein initiating the crack in the glass sample comprises dropping a pin onto the glass sample.

8. A computer-implemented method of analyzing one or more digital shadowgraph images of a crack structure in a glass sample, the method comprising:
converting the one or more digital shadowgraph images into a binary crack structure image;
creating a skeleton structure from the binary crack structure image;
identifying one or more gaps in the binary crack structure image based on the skeleton structure; and
closing the identified one or more gaps in the binary crack structure image.

9. The method of claim 8, further comprising:
identifying fragments of the glass sample in the binary crack structure image after the identified one or more gaps have been closed; and
determining one or more properties of the identified fragments, the one or more properties comprising one or more of: an area, a centroid, a perimeter length, an eccentricity, or a length of a major or minor axis.

10. The method of claim 8, wherein the one or more digital shadowgraph images are images of a final crack structure in a time series of digital shadowgraph images that spans crack initiation and crack propagation in the glass sample, the time series also including a set of initial images prior to crack initiation, the method further comprising:
processing the set of initial images to identify particle debris in the time series of images; and
processing the images of the final crack structure, prior to converting them into the binary crack structure image, to remove the particle debris from the images of the final crack structure.

11. The method of claim 10, wherein processing the set of initial images comprises:
averaging the initial images;
applying a median smoothing to the averaged image to eliminate the particle debris from the image; and
processing the median-smoothed image and the averaged image to obtain a new image containing contributions only from the particle debris wherein processing the median-smoothed image and averaged image comprises:
normalizing the averaged image by the median-smoothed image;
determine a mean intensity of the normalized image; and
subtracting the mean intensity from the normalized image to obtain the new image containing contributions only from the particle debris.

12. The method of claim 8, further comprising, prior to converting the one or more digital images into the binary crack structure image:
generating a correction matrix for each of the one more digital shadowgraph images by applying a median smoothing to the respective image; and
normalizing each of the one or more digital shadowgraph images by the correction matrix generated for the image; and
wherein the one or more digital shadowgraph images comprise multiple images of a final crack structure, and wherein converting the one or more digital shadowgraph images into the binary crack structure image comprises averaging the multiple images of the final crack structure.

13. A computer-implemented method of analyzing a time-resolved sequence of digital shadowgraph images comprising shadowgraph images of a crack propagating in a glass sample, the method comprising:
processing each of the shadowgraph images of the crack propagating in the glass sample by:
converting the shadowgraph image into a binary crack structure image,
creating a skeleton structure from the binary crack structure image, and
identifying crack extremities in the skeleton structure; and
storing coordinates of the identified crack extremities as a function of time.

14. The method of claim 13, wherein identifying the crack extremities comprises:
identifying an initial set of crack extremities,
identifying false positives among the initial set of crack extremities, and
removing the false positives from the initial set to create an updated set of crack extremities.

15. The method of claim 14 wherein the time-resolved sequence of digital shadowgraph images further comprises one or more shadowgraph images of a final crack structure, the method further comprising:
converting the one or more shadowgraph images of the final crack structure into a binary final crack structure image; and
comparing the initial set of crack extremities against the binary final crack structure image to determine which of the crack extremities coincide with the binary final crack structure image,
wherein crack extremities that do not coincide with the binary final crack structure image are identified as false positives.

16. The method of claim 14, wherein crack extremities that are farther from a point of crack initiation than is realistic given a specified maximum crack propagation velocity threshold are identified as false positives.

17. The method of claim 14, further comprising:
identifying, among the stored coordinates of the identified crack extremities as a function of time, duplicates corresponding to coordinates of crack extremities detected at multiple time steps in the time-resolved sequence; and
removing the duplicates by retaining the coordinates only for an earliest of the multiple time steps.

18. The method of claim 13, wherein the time-resolved sequence of digital shadowgraph images further comprises one or more shadowgraph images of a final crack structure, the method further comprising:
converting the one or more shadowgraph images of the final crack structure into a binary final crack structure image; and
determining branchpoints in the final crack structure image.

19. The method of claim 18, further comprising:
classifying the branchpoints between split points, delayed split points, and endpoints based at least in part on the stored coordinates of the identified crack extremities as a function of time.

20. The method of claim 18, further comprising, prior to classifying the branchpoints:
shifting the branchpoints to match the stored coordinates of the identified crack extremities.

21. The method of claim 18, wherein classifying each branchpoint comprises:
determining, based on the stored coordinates of the identified crack extremities as a function of time, a first point in time corresponding to a time when the crack propagating in the glass sample first reached a location of the branchpoint and a second point in time corresponding to a time when the branchpoint first occurred in the crack; and
if a time difference between the second point in time and the first point in time falls below a specified threshold, classifying the branchpoint as a split point, and otherwise classifying the branchpoint as either a delayed split point or an endpoint.

22. The method of claim 21, wherein the time difference between the second point in time and the first point in time does not fall below the specified threshold, wherein classifying the branchpoint further comprises:
determining a first number of objects in a kernel centered at the branchpoint at the second point in time;
determining a second number of objects in a kernel centered at the branchpoint at a third point in time that precedes the second point in time by a specified amount; and
if the first number of objects is one and the second number of objects is two, classifying the branchpoint as an endpoint.

23. The method of claim 18, further comprising:
determining, for each of the branchpoints, a number of associated cracks beginning or ending at the branchpoint and angles of the associated cracks.

24. The method of claim 23, further comprising:
computing, for each of the branchpoints, velocities of the associated cracks.

25. The method of claim 18, further comprising:
identifying individual crack segments in the final binary final crack structure image by setting all pixels within a kernel centered at each of the branchpoints to zero.

26. The method of claim 25, further comprising:
processing the stored coordinates of the identified crack extremities as a function of time to assign each crack extremity to one of the identified individual crack segments.

27. The method of claim 13, further comprising:
processing the stored coordinates of the identified crack extremities as a function of time to determine, for each point in time, a crack wavefront corresponding to instantaneous locations of the extremities; and
measuring an average wavefront propagation velocity based on the determined crack wavefronts.

28. A non-transitory machine-readable medium storing instruction which, when executed by one or more computer processors, cause the one or more computer processors to perform the method of claim 13.

29. A system comprising:
one or more computer processors; and
memory storing instruction which, when executed by the one or more computer processors, cause the one or more computer processors to perform method of claim 13.
